(19) United States
(12) Patent Application Publication
(10) Pub. No.: US 2011/0141207 A1
(43) Pub. Date: Jun. 16, 2011

(54) CONDENSER FOR INK JET PRINTER

(76) Inventors: Ian Fost, Cambs (GB); Carl Mann, St. Ives (GB); Robert Smith, Cambridge (GB)

(21) Appl. No.: 13/057,431

(22) PCT Filed: Aug. 14, 2009
(86) PCT No.: PCT/US09/53838

§ 371 Date: Feb. 3, 2011

(30) Foreign Application Priority Data
Aug. 15, 2008 (US) 61/089279

(51) Int. Cl. B41J 2/17

(52) U.S. Cl. 347/84

(57) ABSTRACT

A condensate recovery system for an ink jet printer includes an ink reservoir and a condenser. The condenser is in fluid communication with the ink reservoir and is adapted to receive exhaust from the ink reservoir and condense solvent from the exhaust. The condenser includes a fluid inlet for receiving the exhaust from the fluid reservoir, a condensing volume in fluid communication with the inlet, a vent in fluid communication with the condensing volume for venting air from the condenser and a fluid outlet for removing condensed solvent from the condenser and returning the condensed solvent to the ink reservoir. A valve is in fluid communication with the condenser fluid outlet and the fluid reservoir. The valve is operable to open and close to control flow of condensed fluid from the condenser to the fluid reservoir.

### CROSS REFERENCE TO RELATED APPLICATIONS

This application claim priority to U.S. Provisional Application No. 61/089,279 filed Aug. 15, 2008, and incorporated herein by reference in its entirety

### BACKGROUND

The present invention relates to ink jet printing and more particularly to a condenser for use in an ink jet printer such as a continuous ink jet printer.

In ink jet printing systems the print is made up of individual droplets of ink generated at a nozzle and propelled towards a substrate. There are two principal systems: drop on demand where ink droplets for printing are generated as and when required; and continuous ink jet printing in which droplets are continuously produced and only selected ones are directed towards the substrate, the others being recirculated to an ink supply.

Continuous ink jet printers supply pressurized ink to a print head assembly, having a drop generator where a continuous stream of ink emanating from a nozzle is broken up into individual regular drops by an oscillating piezoelectric element. The drops are directed past a charge electrode where they are selectively and separately given a predetermined charge before passing through a transverse electric field provided across a pair of deflection plates. Each charged drop is deflected by the field by an amount that is dependent on its charge magnitude before impinging on the substrate whereas the uncharged drops proceed without deflection and are collected at a gutter from where they are recirculated to the ink supply for reuse. A phase measurement system is also usually present as part of deflection plate assembly and is used to ensure synchronization of deflection for the droplets. The charged drops bypass the gutter and hit the substrate at a position determined by the charge on the drop and the position of the substrate relative to the print head assembly. Typically the substrate is moved relative to the print head assembly in one direction and the drops are deflected in a direction generally perpendicular thereto, although the deflection plates may be oriented at an inclination to the perpendicular to compensate for the speed of the substrate (the movement of the substrate relative to the print head assembly between drops arriving means that a line of drops would otherwise not quite extend perpendicularly to the direction of movement of the substrate).

In continuous ink jet printing a character is printed from a matrix comprising a regular array of potential drop positions. Each matrix comprises a plurality of columns (strokes), each being defined by a line comprising a plurality of potential drop positions (e.g. seven) determined by the charge applied to the drops. Thus each usable drop is charged according to its intended position in the stroke. If a particular drop is not to be used then the drop is not charged and it is captured at the gutter for recirculation. This cycle repeats for all strokes in a matrix and then starts again for the next character matrix.

The heater in the print head assembly ensures that the viscosity of the ink, which varies with the ink temperature, is maintained at a value such that the drop generator in the print head assembly works effectively. If the ink is too viscous, because its temperature is too low, or too thin, because it is too hot, then the ink stream will not break up into suitable droplets.

Ink is delivered under pressure to the print head assembly from an ink supply system that is generally housed within a sealed compartment of a cabinet that includes a separate compartment for control circuitry and a user interface panel. The system includes a main pump that draws the ink from a reservoir or tank via a filter and delivers it under pressure to the print head assembly. As ink is consumed the reservoir is refilled as necessary from a replaceable ink cartridge that is releasably connected to the reservoir by a supply conduit. The ink is fed from the reservoir via a flexible delivery conduit to the print head assembly. Electrical power to operate the heater in the print head assembly and the drop generator are supplied by power supply system cables, typically forming part of the supply conduit The unused ink drops captured by the gutter are recirculated to the reservoir via a return conduit, typically located as part of the supply conduit, by a pump. The flow of ink in each of the conduits is generally controlled by solenoid valves and/or other like components.

As the ink circulates through the system, there is a tendency for it to thicken as a result of solvent evaporation. This is particularly a problem in relation to the recirculated ink that has been exposed to air in its passage between the nozzle and the gutter. In order to compensate for this “make-up” solvent is added to the ink as required from a replaceable solvent cartridge so as to maintain the ink viscosity within desired limits when the ink is at the correct operating temperature. This solvent may also be used for flushing components of the print head assembly, such as the nozzle and the gutter, in a cleaning cycle.

The ink supply system is generally vented out of the printer cabinet. However, it has been found that this exhaust may contain solvent and/or ink particles, which creates an undesirable mess.

### BRIEF SUMMARY

In one aspect, a condensate recovery system for an ink jet printer includes an ink reservoir and a condenser. The condenser is in fluid communication with the ink reservoir and is adapted to receive exhaust from the ink reservoir and condense solvent from the exhaust. The condenser includes a fluid inlet for receiving the exhaust from the fluid reservoir, a condensing volume in fluid communication with the inlet, a vent in fluid communication with the condensing volume for venting air from the condenser and a fluid outlet for removing condensed solvent from the condenser and returning the condensed solvent to the ink reservoir. A valve is in fluid communication with the condenser fluid outlet and the fluid reservoir. The valve is operable to open and close to control flow of condensed fluid from the condenser to the fluid reservoir.

In another aspect, a method of removing a fluid from an ink jet printer includes providing an ink reservoir. A passive condenser is in fluid communication with the ink reservoir. Exhaust is received in the condenser from the ink reservoir and solvent is condensed from the exhaust. Air is vented from the condenser. Condensed fluid is removed from the condenser in an intermittent fashion.

The foregoing paragraphs have been provided by way of general introduction, and are not intended to limit the scope of the following claims. The presently preferred embodiments, together with further advantages, will be best understood by reference to the following detailed description taken in conjunction with the accompanying drawings.

### BRIEF DESCRIPTION OF THE DRAWINGS

FIG. 1 is a schematic view showing a portion of an embodiment of an ink jet system and a condenser.

FIG. 2 is a perspective view of an embodiment of a condenser.

FIG. 3 is a side view of the condenser of FIG. 2.

FIG. 4 is a bottom view of the condenser of FIG. 2.

FIG. 5 is a cross-sectional view along line 5-5 of FIG. 4.

FIG. 6 is an image showing a condenser disposed in an embodiment of an ink jet printer.

FIG. 7 is an isometric view of a second embodiment of a condenser assembly.

FIG. 8 is a sectional view along section 8-8 of FIG. 7.

FIG. 9 is an exploded view of the condenser assembly of FIG. 7.

FIG. 10 is an exploded view of the condenser from the condenser assembly of FIG. 7.

FIG. 11 is a perspective view of a portion of the condenser of FIG. 10.

### DETAILED DESCRIPTION

The invention is described with reference to the drawings in which like elements are referred to by like numerals. The relationship and functioning of the various elements of this invention are better understood by the following detailed description. However, the embodiments of this invention as described below are by way of example only, and the invention is not limited to the embodiments illustrated in the drawings.

The present disclosure relates to a condenser and condensate recovery system for use in an ink jet printer such as a continuous ink jet printer. The condenser provides a method of recovering and re-using solvent from the exhaust of an ink reservoir of an ink jet printer.

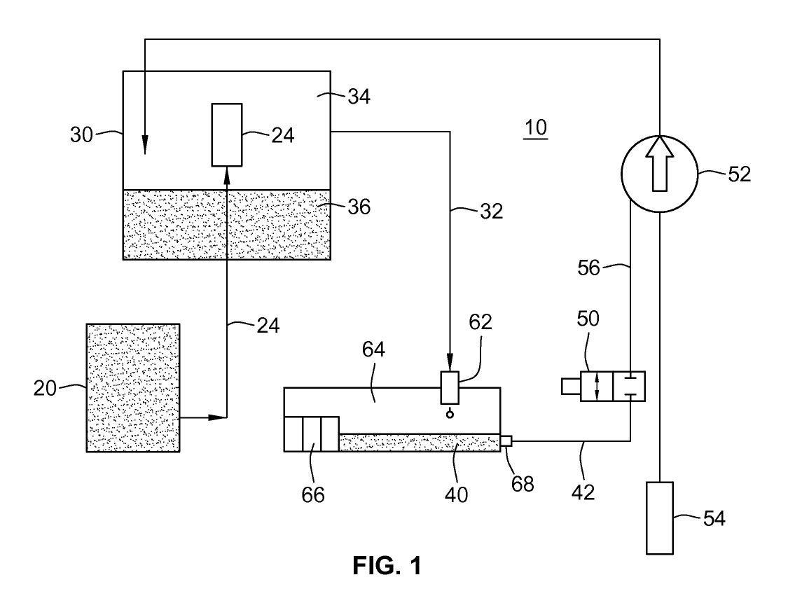

FIG. 1 is a schematic view showing a portion of an embodiment of an ink jet system and a condensate recovery system 10. The condensate recovery system 10 may be a component of an ink jet printer, such as a continuous ink jet printer. The system includes 10 an ink source 20, a fluid reservoir 30, a condenser 40, a valve 50, a pump 52, and a print head 54. The condenser 40 is in fluid communication with the ink reservoir 30. Preferably, a line 32 extends from the reservoir 30 adjacent the vapor 34 about ink 36. The condenser 40 is adapted to receive exhaust from the ink reservoir 30 and condense solvent from the exhaust. Exhaust from the ink reservoir will generally include air with organic solvent (such as methyl ethyl ketone, ethanol, acetone, and the like), and ink particles. The ink reservoir 30 may be under pressure to provide a force to move the exhaust.

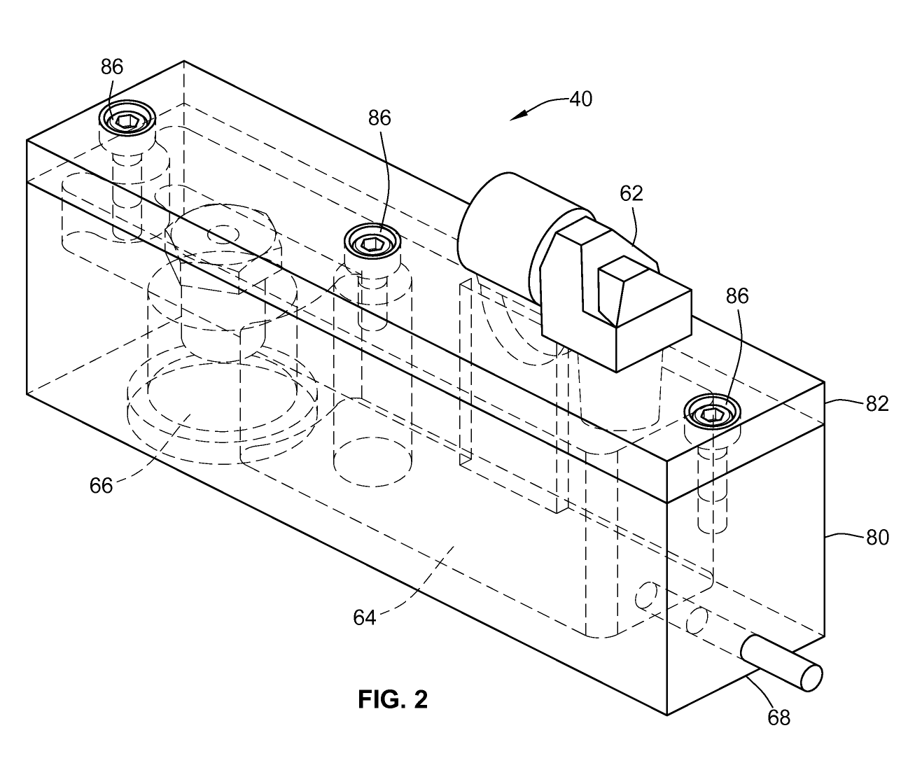

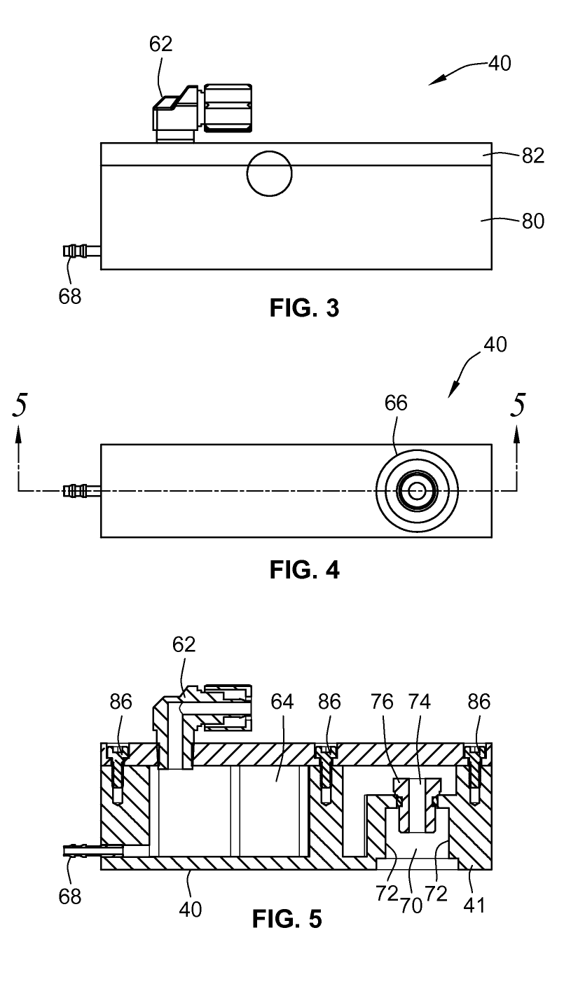

An embodiment of the condenser 40 is shown in FIGS. 2 to 5. The condenser 40 may be a passive condenser, meaning it does not require any power or moving parts to condense liquid. The condenser 40 includes an inlet 62 for receiving the exhaust from the fluid reservoir 30. A condensing volume or chamber 64 is in fluid communication with the inlet 62. Because the walls of the condensing chamber 64 are at a lower temperature than the exhaust, fluid condenses from the exhaust in the condensing chamber 64. This allows condensed solvent and ink particles to be removed from the exhaust stream. The condensing chamber 64 may have a volume of between 50 ml and 1000 ml. A vent 66 is in fluid communication with the condensing chamber 64 for venting from the condenser 40 air from which solvent has been removed. A fluid outlet 68 is configured for removing condensed fluid from the condenser 40 via line 42. Fluid outlet 68 is preferably disposed at a bottom portion of the condenser 40 to facilitate removal of the condensed fluid.

The condenser 40 may be fashioned from a bottom piece 80 and a cover piece 82, as shown in FIG. 2. Cover piece 82 may be connected to bottom piece 80 by a plurality of fasteners 86. The bottom piece 80 and cover piece 82 may be made from any suitable material, such as metal or plastic. Suitable materials include aluminum and polyethylene terephthalate.

Vent 66 is configured to allow gas (primarily air) to escape from the condenser 80, while preventing liquid from escaping. In one embodiment, best seen in FIG. 5, the condenser 40 includes a hollow portion 70 disposed on a bottom portion 41 of the condenser 40. The hollow portion 70 is defined by wall 72 extending upward through the condensing chamber 64. An opening 74 is disposed between the hollow portion 70 and the condensing chamber 40. The opening 74 may be defined by a cylindrical plug or bolt 76. The opening 74 is disposed towards the top of the condenser 40 (i.e. towards cover piece 82) to prevent condensed liquid from existing vent 66 instead of outlet 68.

In normal use, the condenser 40 will only condense fluid at a relatively small rate relative to the condenser volume. Thus, the fluid only needs to be intermittently, rather than continuously, pumped. As shown in FIG. 1, a valve 50 is in fluid communication with the condenser fluid outlet 68 and the fluid reservoir 30. The valve 50 is operable to open and close to control flow of condensed fluid from the condenser 40 back to the fluid reservoir 30. The valve 50 operates in an open position for about 1 to 60 seconds every hour to convey condensed fluid from the condenser 40 back to the ink reservoir 30. In one embodiment, the valve operates in an open position for about 2 to 10 seconds, preferably about 5 seconds, every hour.

A pump 52 is in fluid communication with the fluid outlet 68 to draw condensed fluid from the condenser 40 into the fluid reservoir 30 via line 56. In one embodiment, the pump 52 is the gutter pump of the ink jet printer. The gutter pump 52 normally returns fluid from the print head 54 to the ink reservoir 30. When valve 50 is open, however, gutter pump 52 also conveys condensed fluid from the condenser 40 to the ink reservoir 30. When valve 50 is open, gutter pump 52 may run at a higher rate than normal to maintain a constant flow rate from the print head 54.

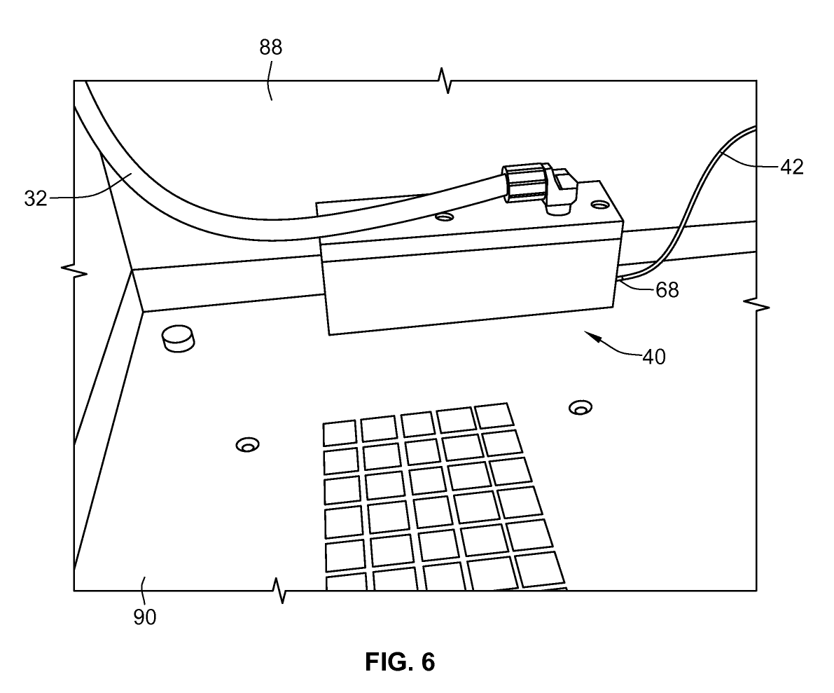

As best seen in FIG. 6, the condenser 40 may be disposed within a cabinet 88 containing an ink jet system of the ink jet printer. The condenser 40 is preferably disposed on a bottom portion 90 of the cabinet 88. The inlet 62 is disposed on a top portion of the condenser 40. The vent 66 (not visible in FIG. 6) is disposed on a bottom portion of the condenser 40 and extends through the bottom portion 90 of the cabinet 88. The fluid outlet 68 is disposed on a lower portion of a side of the condenser 40.

In another embodiment, an alternative pump arrangement may be used. For example, the system may use a different or additional pump disposed in the fluid reservoir to draw fluid from the condenser to the ink reservoir 30. The pump used may be a venturi pump.

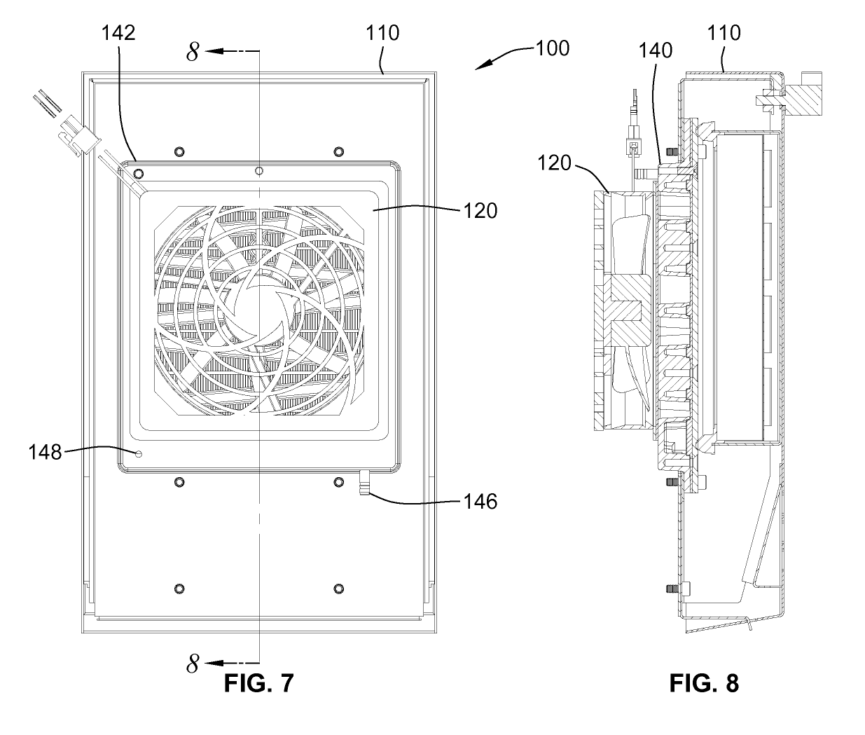

A second embodiment of a condenser assembly 100 is shown in FIGS. 7 to 11. The condenser assembly 100 includes a housing 110 and optionally a fan 120, as shown in FIG. 7. Disposed within the housing 110 is a condenser 140. The condenser assembly 100 and/or condenser 140 may be used in a similar fashion as condenser 40. In particular, the condenser 140 is in fluid communication with the ink reservoir 30. The condenser assembly 100 uses the condenser 140 to condense solvent from the solvent-rich exhaust from the ink reservoir 30. The condenser assembly 100 includes a fluid inlet 142, a vent or gas outlet 146, and fluid outlet 148. The condenser 140 may be a passive condenser, meaning it does not require any power or moving parts to operate.

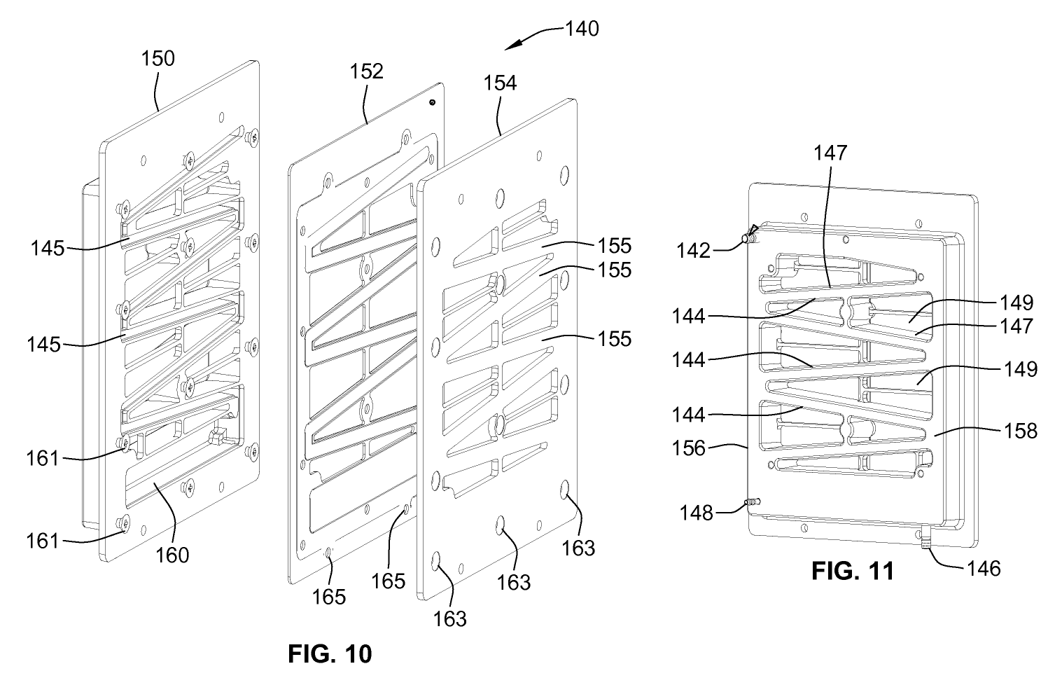

Turning to FIGS. 10 and 11, the condenser 140 includes an inlet 142 for receiving the exhaust from the fluid reservoir 30. Channels 144 are disposed across the condenser 140, to provide a condensing volume with surface area for removing heat from the exhaust, thus allowing solvent to condense from the exhaust. As best seen in FIG. 11, a vent outlet 146 is in fluid communication with the channels 144 for venting air from the condenser 140. A fluid outlet 148 is configured for removing condensed fluid from the condenser 140. The fluid inlet 142 is disposed at a top portion of the condenser 140 and the fluid outlet 148 is disposed at a bottom portion of the condenser 140. The condenser 140 includes lateral side portions 156, 158, with the channels 144 disposed in an angled fashion between the lateral side portions 156, 158, with adjacent channels 144 interconnected to provide a continuous fluid channel through the condenser 140.

As shown in FIG. 10, the condenser 140 may be composed of a front portion 150 and a back plate 154, with a gasket 152 disposed in between to prevent leakage of fluid. The components may be held together with fasteners 161 disposed through holes 163 and 165. The condenser front portion 150 includes the channels 144, which have inner surfaces 145 and outer surfaces 147. Back plate 154 is essentially flat with portions 155 that correspond to the channels 144. The outer surface 147 of the channels 144 is preferably well-exposed to the ambient air through the use of openings 149 therebetween to ensure good air circulation.

The condenser 140 may also include a chamber 160 disposed towards the bottom of the condenser 140. The chamber 160 provides a collection volume for condensed fluid and is in fluid communication with fluid outlet 148 and vent 146. The opening into vent 146 from chamber 160 is disposed at a top portion of chamber 160, above the opening into fluid outlet 148, so that condensed liquid flows into fluid outlet 148 and not into vent 146. Thus, fluid outlet 148 is preferably disposed at a bottom portion of the condenser 140 to permit removal of the condensed fluid.

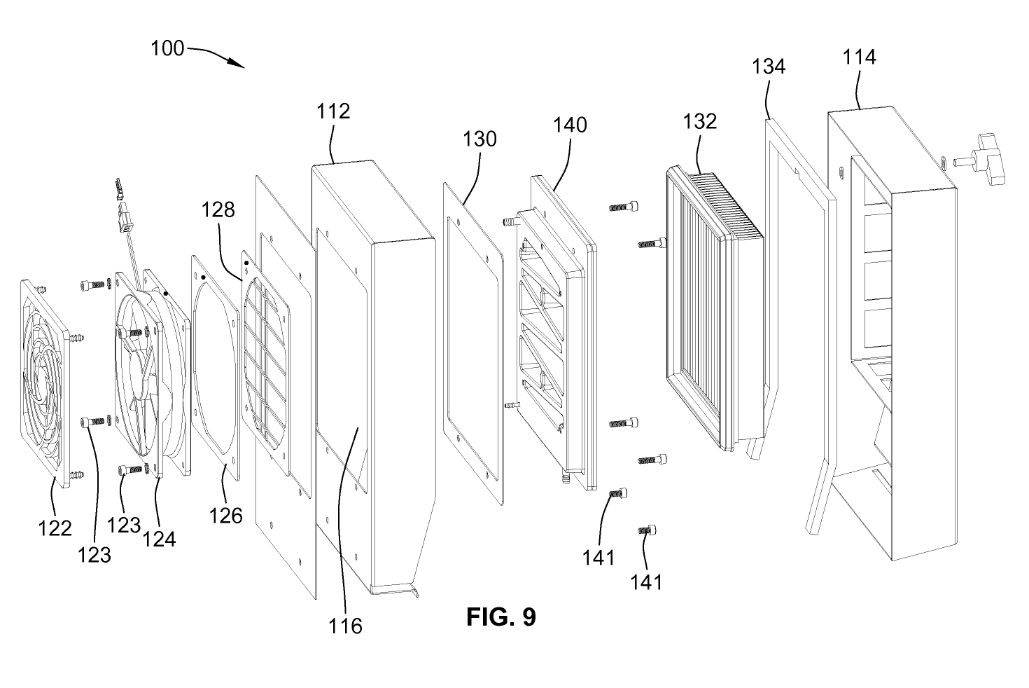

As previously described, condenser 140 may be used in conjunction with the condenser assembly 100. Referring to FIGS. 7 and 8, the condenser assembly 100 is preferably disposed on a side portion of the housing of an ink jet printer, with fan 120 disposed on an exterior portion of the printer housing. Fan 120 may be used to generate air flow through openings 149 and around channels 144 of condenser 140, thus helping to cool the solvent-laden exhaust therein and enhance condensation of solvent. Turning to FIG. 9, a suitable embodiment of a condenser assembly 100 is shown. Fan 120 includes cover 122, electric fan 124, gasket 126, and grill 128. Housing 110 includes a front portion 112 and a rear portion 114. Front housing 112 includes opening 116, through which a portion of condenser 140 may be disposed. Condenser gasket 130 may be disposed between condenser 140 and front housing 112. The condenser assembly 100 may include a filter 132. The fan 124 preferably blows air from outside the printer housing into the interior of the printer, and filter 132 filters the (often dusty) exterior air; this may be used, for example, to retain the printer's IP rating. Gasket 134 is disposed between filter 132 and rear housing portion 114. Fasteners 123 and 141 may be used to hold various components together. Knob 136 is used to retain the rear housing portion 114.

The various components of the condenser 40 and condenser assembly 100 may be made from any suitable conventional material. Condenser 140 is preferably made from a material with good thermal conductivity, such as aluminum.

When the condenser assembly 140 is used, the valve 50 may be opened more frequently than in the system using condenser 40. It is preferably used in an intermittent fashion. Thus, in one embodiment, the valve 50 operates in an open position for about 1 to 60 seconds every 10 minutes to convey condensed fluid from the condenser 40 back to the ink reservoir 30; at the other times, the valve is closed. In another embodiment, the valve operates in an open position for about 2 to 10 seconds, preferably about 5 seconds, every 10 minutes.

The described and illustrated embodiments are to be considered as illustrative and not restrictive in character, it being understood that only the preferred embodiments have been shown and described and that all changes and modifications that come within the scope of the inventions as defined in the claims are desired to be protected. It should be understood that while the use of words such as “preferable”, “preferably”, “preferred” or “more preferred” in the description suggest that a feature so described may be desirable, it may nevertheless not be necessary and embodiments lacking such a feature may be contemplated as within the scope of the invention as defined in the appended claims. In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

What is claimed is:

1. A condensate recovery system for an ink jet printer comprising:
an ink reservoir;
a condenser in fluid communication with the ink reservoir, the condenser adapted to receive exhaust from the ink reservoir and condense solvent from the exhaust, the condenser comprising:
a fluid inlet for receiving the exhaust from the fluid reservoir;
a condensing volume in fluid communication with the inlet;
a vent in fluid communication with the condensing volume for venting air from the condenser; and
a fluid outlet for removing condensed solvent from the condenser and returning the condensed solvent to the ink reservoir; and
a valve in fluid communication with the condenser fluid outlet and the fluid reservoir, the valve operable to open and close to control flow of condensed fluid from the condenser to the fluid reservoir.

2. The condensate recovery system of claim 1 further comprising a pump in fluid communication with the fluid outlet to draw condensed fluid from the condenser into the fluid reservoir.

3. The condensate recovery system of claim 2, wherein the pump is a gutter pump of the ink jet printer.

4. The condensate recovery system of claim 3 wherein the ink jet printer is a continuous ink jet printer and the gutter pump is in fluid communication with a print head of the continuous ink jet printer.

5. The condensate recovery system of claim 2 wherein the pump is a venturi pump.

6. The condensate recovery system of claim 1, wherein the condenser comprises:
a hollow portion disposed on a bottom portion of the condenser, and in fluid communication with the vent portion, the hollow portion defined by walls extending upward through the condensing volume, and
an opening between the hollow portion and the condensing volume.

7. The condensate recovery system of claim 1 wherein the valve operates in an open position for about 1 to 60 seconds every hour to convey condensed fluid from the condenser to the ink reservoir.

8. The condensate recovery system of claim 1 wherein the valve operates in an open position for about 1 to 60 seconds every ten minutes to convey condensed fluid from the condenser to the ink reservoir.

9. The condensate recovery system of claim 1 wherein the condenser is disposed within a cabinet containing an ink jet system of the ink jet printer.

10. The condensate recovery system of claim 9 wherein the condenser is disposed on a bottom portion of the cabinet, wherein the fluid inlet is disposed on a top portion of the condenser, the vent is disposed on a bottom portion of the condenser and extends through a bottom portion of the cabinet, and the fluid outlet is disposed on a lower portion of a side of the condenser.

11. The condensate recovery system of claim 1 wherein the condensing volume has a volume of between 50 ml and 1000 ml.

12. The condensate recovery system of claim 1 wherein the condensing volume comprises a plurality of channels disposed between the fluid inlet and the fluid outlet.

13. The condensate recovery system of claim 12 further comprising a fan configured to blow air past an outer surface of the plurality of channels.

14. The condensate recovery system of claim 12 wherein the fluid inlet is disposed at a top portion of the condenser and the fluid outlet is disposed at a bottom portion of the condenser, the condenser comprising lateral side portions, wherein the plurality of channels are disposed in an angled fashion between the lateral side portions and adjacent channels are interconnected.

15. The condensate recovery system of claim 1 wherein exhaust from the ink reservoir comprises air, organic solvent, and ink particles.

16. The condensate recovery system of claim 1 wherein the condenser is a passive condenser.

17. A method of removing a fluid from an ink jet printer comprising:
providing an ink reservoir;
providing a passive condenser in fluid communication with the ink reservoir;
receiving exhaust from the ink reservoir in the condenser and condensing solvent from the exhaust;
venting air from the condenser; and
removing condensed fluid from the condenser in an intermittent fashion.

18. The method of claim 17, wherein the condensed fluid is removed from the condenser with the gutter pump of the ink jet printer.

19. The method of claim 17, wherein the condenser is disposed within a cabinet containing an ink jet system of the ink jet printer.

20. The method of claim 17, further comprising blowing air across the condenser to enhance the condensing of fluid.
